(19) United States
(12) Patent Application Publication
(10) Pub. No.: US 2009/0126767 A1
(43) Pub. Date: May 21, 2009

(54) Dishwasher using electrolized alkaline water

(75) Inventor: Yousuke Saitou, Aichi-ken (JP)

Correspondence Address: REED SMITH LLP, Suite 1400, 3110 Fairview Park Drive, Falls Church, VA, 22042, US

(73) Assignee: Hoshizaki Denki Kabushiki Kaisha

(21) Appl. No.: 12/232,568

(22) Filed: Sep. 19, 2008

(30) Foreign Application Priority Data
Sep. 20, 2007 (JP) 2007-244455

(51) Int. Cl. B08B 3/04

(52) U.S. Cl. 134/56 D

(57) ABSTRACT

A control system of a dishwasher in combination with an electrolyzed water production apparatus installed independently from the dishwasher, wherein electrolyzed alkaline water stored in a washing tank from the electrolyzed water production apparatus is used as washing water at a washing process and fresh water stored in a rinse tank from a source of water is used as rinse water at a rinse process, after the washing process; comprising the steps of activating the dishwasher to start operation at the rinse process so that the rinse water from the rinse tank is supplied into and stored in the washing tank; introducing the electrolyzed strong alkaline water into the washing tank in response to start of operation at the rinse process so that the alkaline water is diluted with the rinse water in the washing tank; and stopping the introduction of the electrolyzed alkaline water into the washing tank after lapse of a predetermined time.

### BACKGROUND OF THE INVENTION

1. Field of the Invention

The present invention relates to a dishwasher of the type using electrolyzed alkaline water.

2. Discussion of the Prior Art

As one of conventional dishwashers, there has been provided a dishwasher of the type in which washing water in a washing tank is used at a washing process and rinse water in a rinse tank or booster tank is used at a rinse process. This type of dishwasher is used widely in general, wherein an amount of water containing a detergent dissolved therein is used as washing water.

In use of the dishwasher of the type described above, it is required from a point of view for protection of environment to reduce the amount of detergent used for washing, desirably to refrain use of the detergent. Under such requirements, high washing resolution of electrolyzed alkaline water produced in an electrolytic cell of the type with a partition membrane is noticed to use the electrolyzed alkaline water for substitution of the detergent. Proposed in the following patent documents are dishwashers capable of using the electrolyzed alkaline water for substitution of the detergent.

The dishwashers proposed in the patent documents each are provided integrally with an electrolytic cell designed only for use therein. For example, the dishwasher proposed in the patent document (1) is provided with an electrolytic cell assembled therein. In the dishwasher proposed in the patent document (2), an electrolytic cell is disposed in a conduit for connection to a mineral removal device placed at an outside of the housing body of the dishwasher and to an alkaline rinse tank. The dishwasher proposed in the patent document (3) is provided with an electrolytic cell assembled in an outer box of the dishwasher only for washing.

Patent document (1): Laid-open Publication for Patent No. Hei8-47473

Patent document(2): Laid-open Publication for Patent No. 2003-265395

Patent document(2): Laid-open Publication for Patent No. 2003-325426

As the dishwashers each are provided with the electrolytic cell only for washing, the cost of the dishwasher becomes expensive. For this reason, the dishwasher with the electrolytic cell is not utilized at present despite of useful for washing. On the other hand, the electrolytic cell itself is widely used in a condition installed in a kitchen room separately from the dishwasher. In use of the electrolytic cell, electrolyzed acid water is used for sterilization of various foods and dishes, while electrolyzed alkaline water is used in a small amount for washing pollutant of the foods and dishes.

The present invention was made for utilizing electrolyzed alkaline water used in a smaller amount than electrolyzed acid water produced in an electrolytic cell independently from a dishwasher. An object of the present invention is to provide a dishwasher capable of utilizing electrolyzed alkaline water produced in an electrolytic cell installed separately therefrom thereby to refrain use of detergent for washing water.

According to the present invention, there is provided a control system of a dishwasher in combination with an electrolyzed water production apparatus installed independently from the dishwasher, wherein electrolyzed alkaline water stored in a washing tank from the electrolyzed water production apparatus is used as washing water at a washing process and fresh water stored in a rinse tank from a source of water is used as rinse water at a rinse process after the washing process, comprising the steps of activating the dishwasher to start operation at the rinse process so that the rinse water from the rinse tank is supplied into and stored in the washing tank; introducing the electrolyzed strong alkaline water into the washing tank in response to start of operation at the rinse process so that the alkaline water is diluted with the rinse water in the washing tank; and stopping the introduction of the electrolyzed alkaline water into the washing tank after lapse of a predetermined time.

In a practical embodiment of the present invention, it is preferable that the supply of fresh water into the rinse tank is stopped during introduction of the electrolyzed alkaline water into the washing tank. It is also preferable that the supply of rinse water into the rinse tank is permitted during operation of the dishwasher at the washing process.

According to an aspect of the present invention, there is provided a control system of a dishwasher in combination with an electrolyzed water production apparatus installed independently from the dishwasher, wherein electrolyzed alkaline water stored in a washing tank from the electrolyzed water production apparatus is used as washing water at a washing process and hot water stored in a rinse tank from a booster tank is used as rinse water at a rinse process after the washing process; comprising the steps of activating the dishwasher to start operation at the rinse process so that the rinse water from the rinse tank is supplied into and stored in the washing tank; introducing the electrolyzed strong alkaline water into the washing tank in response to start of operation at the rinse process so that the alkaline water is diluted with the rinse water in the washing tank; and stopping the introduction of the electrolyzed alkaline water into the washing tank after lapse of a predetermined time.

In a practical embodiment of the control system, it is preferable that fresh water supplied into the booster tank is heated in a condition where the booster tank was fully filled with the fresh water.

### BRIEF DESCRIPTION OF THE DRAWINGS

In the drawings:

FIG. 1 is a schematic illustration of a first embodiment of a dishwasher according to the present invention;

FIG. 2 is a flow chart of a control program for washing operation executed by an electric controller;

FIG. 3 is a flow chart of a control program for electrolytic operation of an electrolyzed water production apparatus installed independently from the dishwasher;

FIG. 4 is a schematic illustration of a second embodiment of a dishwasher according to the present invention;

FIG. 5 is a flow chart of a control program for electrolytic operation of the electrolyzed water production apparatus;

FIG. 6 is a schematic illustration of a third embodiment of a dishwasher according to the present invention;

FIG. 7 is a flow chart of a control program for electrolytic operation of the electrolyzed water production apparatus executed by the controller in the third embodiment;

FIG. 8 is a schematic illustration of a fourth embodiment of a dishwasher according to the present invention;

FIG. 9 is a flow chart of a control program for washing operation executed by the controller in the fourth embodiment;

FIG. 10 is a flow chart of a control program for preparation of rinse water in a booster in the fourth embodiment; and

FIG. 11 is a flow chart of a control program for electrolytic operation of the electrolyzed water production apparatus in the fourth embodiment.

### DESCRIPTION OF THE PREFERRED EMBODIMENT

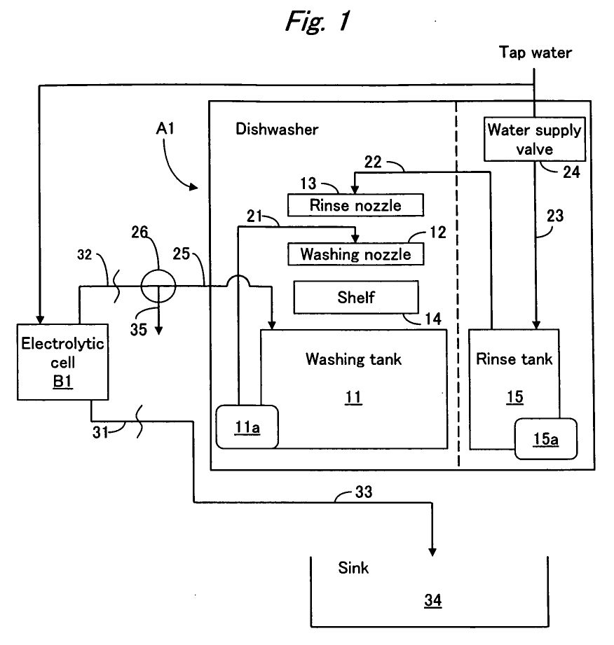

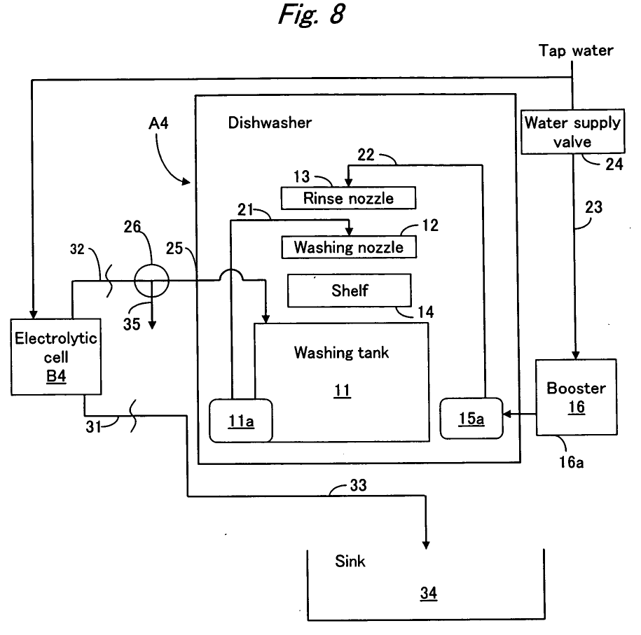

The present invention relates to a dishwasher of the type which is operated to effect a washing process using electrolyzed alkaline water stored in a washing tank and a rinsing process using cold or hot water stored in a rinse tank or a booster tank. The electrolyzed alkaline water is produced in an electrolytic cell of an electrolyzed water production apparatus installed separately from the dishwasher and supplied as the washing water into the washing tank. Illustrated in FIGS. 1, 4 and 6 are three practical embodiments of the present invention. In FIG. 8, there is illustrated another practical embodiment of a dishwasher according to the present invention.

In FIG. 1, there is schematically illustrated a first embodiment of a dishwasher A1 according to the present invention An electrolyzed water production apparatus B1 is installed separately from the dishwasher A1 to produce electrolyzed alkaline water to be used as washing water in the dishwasher. The dishwasher A1 itself is well known in the art, and the electrolyzed water production apparatus B1 is also well known in the art. The dishwasher A1 is provided with a washing tank 11 placed on the bottom portion of a washing chamber formed in a housing body. A washing nozzle 12 is provided above the washing tank 11, and a rinse nozzle 13 is provided above the washing nozzle 12. A tableware shelf 14 is mounted within the washing chamber at a position between the washing tank 11 and the washing nozzle 12. The dishwasher A1 is also provided with a rinse tank 15 in a mechanic chamber formed within the housing body.

In operation of the dishwasher A1, a washing pump 11a is driven by an electric motor (not shown) at a washing process to supply washing water from the washing tank 11 to the washing nozzle 12 through a water supply conduit 21. The washing water is spouted from the washing nozzle 12 for washing tableware placed on the shelf 14 and falls in the washing tank 11. The washing pump 11a is operated for a predetermined time to circlate the washing water into the washing tank 11 through the washing nozzlel2 thereby to expedite washing of the tableware. After finish of washing of the tableware in the shelf, the used washing water in the washing tank 11 is drained for subsequently starting at a rinsing process. The supply of washing water into the washing tank 11 is controlled as described later.

In operation of the dishwasher A1 at the rinsing process, a rinse pump 15a is driven by an electric motor (not shown) to supply cold water or hot rinse water to the rinse nozzle 13 through a water supply conduit 22. The rinse water is spouted from the rinse nozzle 13 to rinse the washed tableware in the shelf 14 and falls in the washing tank 11. When a predetermined amount of rinse water was spouted from the rinse nozzle 13, the rinse pump 15a is stopped to finish the operation at the rinsing process. After finish of the rinsing process, an amount of fresh water is introduced into the washing tank 11. The fresh water is supplied as rinse water through a water supply conduit 23 in connection to a tap water pipe under control of a water supply valve 24. When the rinse tank 15 is filled with the rinse water, the water supply valve 24 is closed to stop supply of the rinse water.

The electrolyzed water production apparatus B1 installed separately from the dishwasher A1 includes an electrolytic cell with a partition membrane which is supplied with diluted brine of a predetermined concentration to produce electrolyzed strong acid water in its anode chamber and to produce electrolyzed strong alkaline water in its cathode chamber. In this embodiment, the electrolytic condition of the brine is determined to produce electrolyzed acid water of extremely low pH about “2” and to produce electrolyzed alkaline water of extremely high pH about “12”.

The electrolytic cell is provided with a discharge conduit 31 only for the electrolyzed acid water and a discharge conduit 32 only for the electrolyzed alkaline water. The discharge conduit 31 is connected to a branch conduit 33 extended above a sink 34 in a kitchen to discharge the electrolyzed acid water for germicidal washing of various foods. The discharge conduit 32 is connected to a branch conduit 25 extended above the washing tank 11 of dishwasher A1 and connected to a branch conduit 35 through a flow changeover valve 26. With such arrangement of the discharge conduit 32, the electrolyzed strong alkaline water is selectively supplied to the branch conduits 25 or 35 by operation of the flow changeover valve 26.

In the dishwasher A1, the electrolyzed strong alkaline water produced in the electrolytic cell is introduced into the washing tank 11 through the branch conduit 25 by operation of the flow changeover valve 26 and is diluted with the rinse water in the washing tank 11 to prepare washing water of a predetermined concentration. The preparation of washing water is carried out in response to start of operation at the rinsing process in the dishwasher Al and activation of the electrolyzed water production apparatus B1, The introduction of the electrolyzed strong alkaline water into the washing tank 11 is started in response to start of operation at the rinsing process and stopped after lapse of a predetermined time.

With such preparation of the washing water, the electrolyzed strong alkaline water is introduced into the washing tank 11, and the rinse water is introduced into the washing tank 11 in response to start of operation at the rinsing process in the dishwasher. Thus, the electrolyzed strong alkaline water is diluted with the rinse water at the predetermined ratio and prepared as the washing water of a predetermined washing resolution. When the washing tank 11 is not filled with the washing water, the introduction of the electrolyzed strong alkaline water and the rise water is repeated until the washing tank 11 is filled with the washing water. Thus, the electrolyzed strong alkaline water produced in the electrolytic cell installed separately from the dishwasher is utilized as the washing water in the dishwasher.

In the preparation of the washing water, it is preferable that supply of the rinse water into the rinse tank 15 is stopped while the electrolyzed alkaline water is being introduced into the washing tank 11. Under such preparation of the washing water, the rinsing process is not started until the predetermined amount of the electrolyzed strong alkaline water is introduced into the washing tank 11 after finish of the preceding rinsing process. If the level of the rinse water in the rinse tank 15 is low during the washing process in the dishwasher A1, the rinsing process may not be started after the washing process. To avoid such trouble, the rinse water may be supplied into the rinse tank 15 during the washing process.

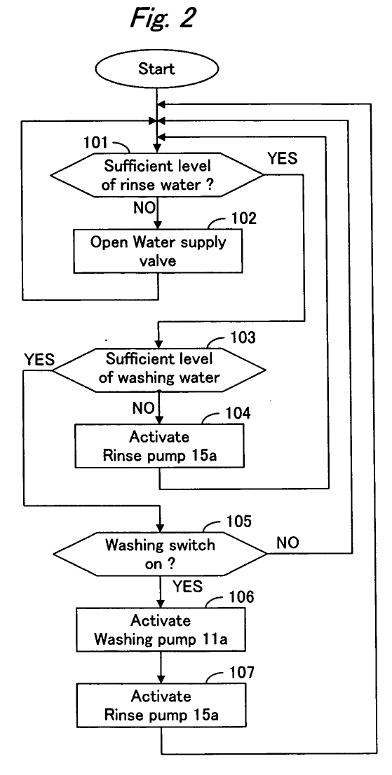

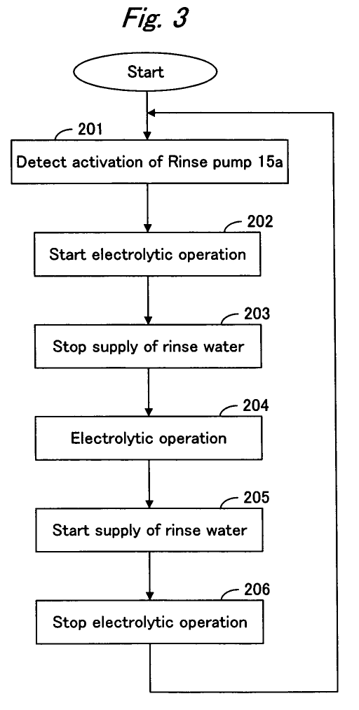

A flow chart of a control program for washing operation of the dishwasher A1 is shown in FIG. 2, and a flow chart of a control program for operation of the electrolyzed water production apparatus is shown in FIG. 3. When an electric controller (not shown) of the dishwasher A1 initiates to execute the control program for washing operation, the controller determines the level of rinse water in the rinse tank 15 at step 101. If the level of rinse water is insufficient, the controller determines a “No” answer and causes the water supply valve 24 at step 102 to open for supply of the fresh tap water into the rinse tank 15. When the level of rinse water in the rinse tank 15 becomes sufficient, the controller determines a “Yes” answer at step 101 and determines at step 103 the level of washing water in the washing tank 11. If the level of washing water is insufficient, the controller determines a “No” answer at step 103 and activates the rinse pump 15a at step 104 to supply the washing water into the washing tank. When the level of washing water becomes sufficient, the controller determines a “Yes” answer at step 103 and determines whether a washing switch (not shown) for washing operation is turned on or not. If the answer at step 105 is “No”, the controller causes the program to return to step 101. When the washing switch is turned on, the controller determines a “Yes” answer at step 105 and activates the washing pump 11a at step 106 to start operation at the washing process. After lapse of a predetermined time, the controller deactivates the washing pump 11a and causes a drain valve (not shown) to discharge the washing water from the washing tank 11. Thereafter, the controller activates the rinse pump 15a at step 107 to start operation at the rinse process and returns the program to step 101 after finish of the rinse process.

When the dishwasher A1 is activated to start operation at the rinse process, the controller activates the electrolyzed water production apparatus B1 and executes the control program for electrolytic operation shown by a flow chart in FIG. 3. When detected the operation of the rinse pump 15a at step 201, the controller turns on a start switch (not sown) of the electrolyzed water production apparatus B1 and switches over the flow changeover valve 26 to start the activation of the electrolyzed water production apparatus B1 at step 202. Subsequently, the controller closes the water supply valve 24 at step 203 to stop the supply of water into the rinse tank 15. Thus, the operation of the dishwasher at the rinse process is continued for a predetermined time at step 204. Upon lapse of the predetermined time, the controller causes the water supply valve 24 at step 205 to open for restart of supply of the water into the rinse tank 15 and deactivates the electrolyzed water production apparatus B1 at step 206.

With such preparation of the washing water, the washing tank 11 is supplied with the electrolyzed strong alkaline water from the electrolyzed water production apparatus B1 activated at the rinse process of the dishwasher A1 and is supplied with rinse water used at the rinse process. As a result, the electrolyzed strong alkaline water is diluted with the rinse water at a predetermined ratio so that the washing water of desired washing resolution is prepared with a stable characteristic. Thus, the electrolyzed strong alkaline water produced in the electrolyzed water production apparatus installed separately from the dishwasher A1 can be utilized as the washing water in the dishwasher A1.

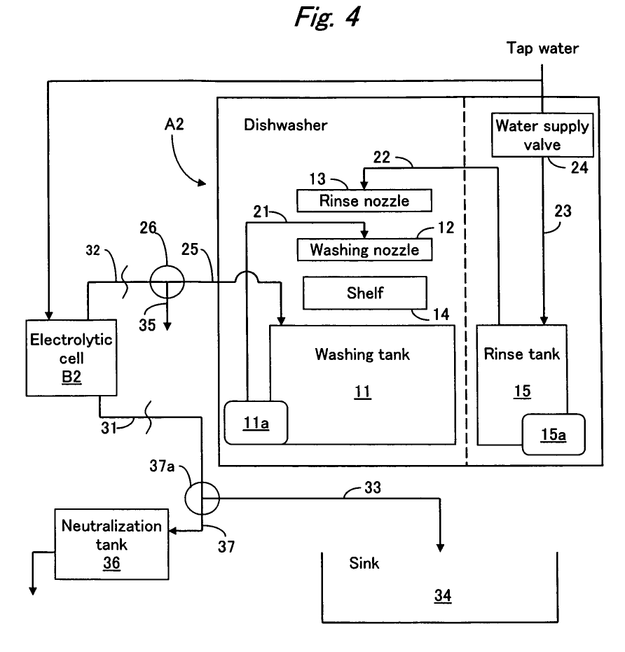

Illustrated in FIG. 4 is a second embodiment of a dishwasher A2 according to the present invention. In this second embodiment, a neutralization tank 36 is disposed in a drain conduit 37 bifurcated from the branch conduit 33 extending into the sink 34, and a second changeover valve 37a is disposed in the bifurcated portion of branch conduit 33. The dishwasher A2 is the same as the dishwasher in the first embodiment, and an electrolyzed water production apparatus B2 is the same as the electrolyzed water production apparatus B1 in the first embodiment. The neutralization tank 36 is provided to store an amount of calcium carbonate for increasing pH of electrolyzed acid water and an amount of activated carbon, sodium thiosulfate or the like for eliminating chlorine component. The second changeover valve 37a is provided with an on-off switch (not shown) to be activated under control of the controller. When the on-off switch is turned on, the changeover valve 37a is switched over to connect the discharge conduit 31 to the branch conduit 33. When the on-off switch is turned off, the changeover valve 37a is switched over to connect the discharge conduit 31 to the drain conduit 37. The electrolyzed water production apparatus B2 is. activated while the on-off switch of changeover switch 37a is maintained in its on-position.

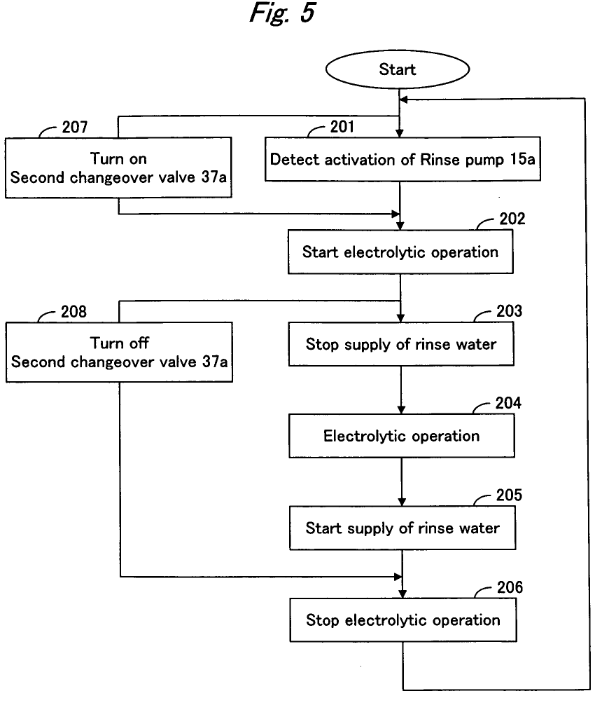

In this embodiment, the controller executes the program for washing operation shown in FIG. 2 to operate the dishwasher A2 in the same manner as in the first embodiment. On the other hand, the electrolyzed water production apparatus is operated under execution of a control program for electrolytic operation shown by a flow chart in FIG. 5.

To prepare washing water in the washing tank 11, the controller executes processing at step 201˜206 of the control program for electrolytic operation in the same manner as in the control of the electrolyzed water production apparatus B1 of the first embodiment. After preparation of the washing water in the washing tank 11, the controller turns on the on-off switch of second changeover valve 37a at step 207 to connect the discharge conduit 31 to the branch conduit 33 and executes the processing at step 202 to activate the electrolyzed water production apparatus B2. After start of the electrolytic operation, the controller turns off the on-off switch of second changeover valve 37a at step 208 to connect the discharge conduit 31 to the drain conduit 37 in connection to the neutralization tank 36.

With such execution of the control program for electrolytic operation, the electrolyzed strong acid water produced in the electrolyzed water production apparatus B2 during supply of the electrolyzed strong alkaline water into the washing tank 11 of dishwasher A2 is introduced into the neutralization tank 36. Thus, the electrolyzed strong acid water is neutralized in the neutralization tank 36 and drained without causing any difficulty in the water.

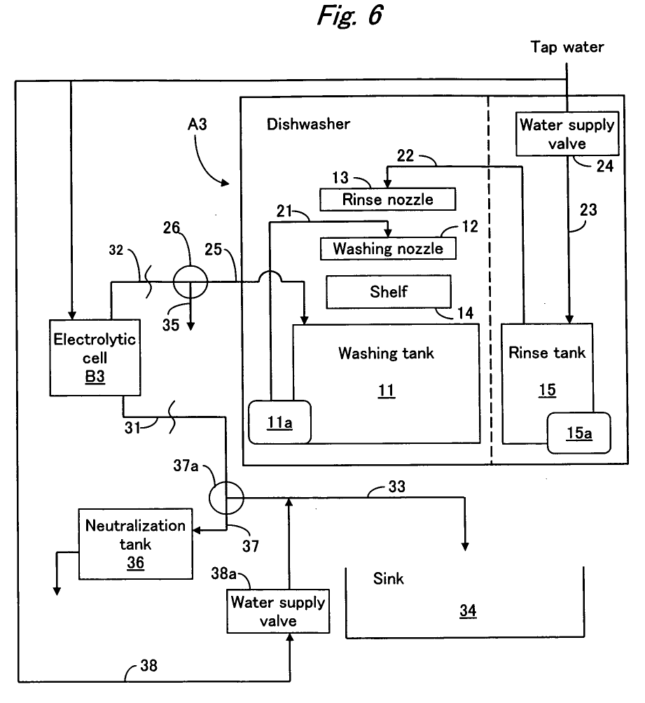

Illustrated in FIG. 6 is a third embodiment of a dishwasher A3 according to the present invention. In this third embodiment, an introduction conduit 38 for supply of tap water into the discharge conduit 33 extending into the sink 34, and a second water supply valve 38a is disposed in the introduction conduit 38 is provided. In an electrolytic cell B3 for the dishwasher A3, electrolyzed strong alkaline water of about pH 12 is produced for preparation of washing water to be used in the dishwasher A3, while electrolyzed strong acid water of pH 2 is produced. As pH of the electrolyzed strong acid water is low, the chlorine component contained in the acid water volatilizes as chlorine gas due to vibration applied thereto. This causes corrosion of surrounding metallic parts. It is, therefore, desirable to increase pH of the electrolyzed acid water used in the sink up to 2.6˜3.5 for restraining the occurrence of chlorine gas. For this reason, when the electrolyzed strong acid water is used in the sink 34, the second water supply valve 38a is opened to introduce fresh tap water into to the acid water flowing the discharge conduit 33 thereby to increase pH of the acid water to about 2.6˜3.5.

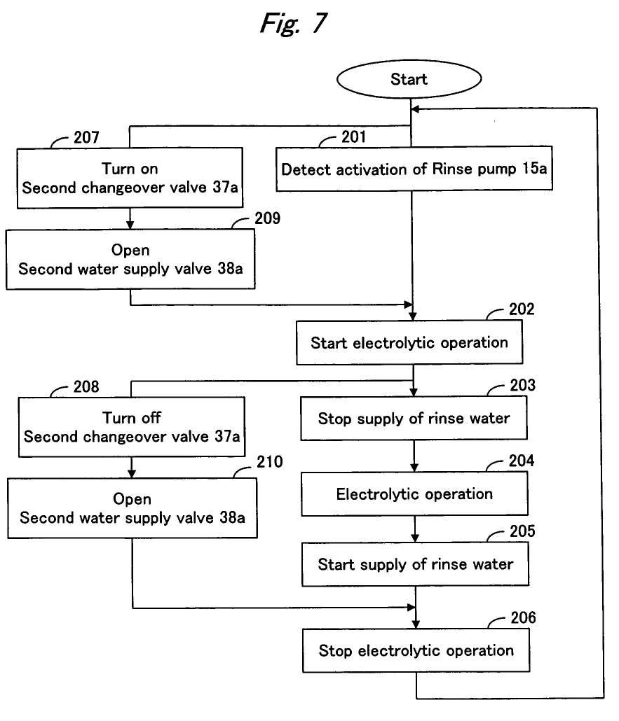

In this third embodiment, the controller executes the control program for washing operation shown in FIG. 2 in the same manner as in the first embodiment. On the other hand, the electrolyzed water production apparatus B3 is operated under execution of a control program for electrolytic operation shown by a flow chart in FIG. 7.

To prepare washing water in the washing tank 11, the controller executes processing at step 201˜206 of the control program for electrolytic operation in the same manner as in the control of the electrolyzed water production apparatus B1 of the first embodiment. In this instance, the controller switches over the changeover valve 37a at step 207 to connect the discharge conduit 31 to the branch conduit 33, opens the second water supply valve 38a at step 209 and executes the processing at step 202 to activate the electrolyzed water production apparatus B3. When the changeover valve 37a is switched over at step 208 to connect the discharge conduit 31 to the drain conduit 37 after start of the electrolytic operation, the controller closes the second water supply valve 38a to stop supply of the fresh water from the introduction conduit 38 into the branch conduit 33.

Illustrated in FIG. 8 is a fourth embodiment of a dishwasher A4 according to the present invention. In this fourth embodiment, a booster 16 is installed outside the housing body of dishwasher A4 for supplying hot water as rinse water into the rinse nozzle 13 by operation of the rinse pump 15a. The booster 16 is in the form of a booster tank 16a of the water heater type which is supplied with fresh water from the water supply conduit through the water supply valve 24. When the level of fresh water stored in the booster tank 16a becomes a predetermined level, the fresh water is heated and supplied as hot rinse water into the rinse nozzle 22 in operation of the rinse pump 15a.

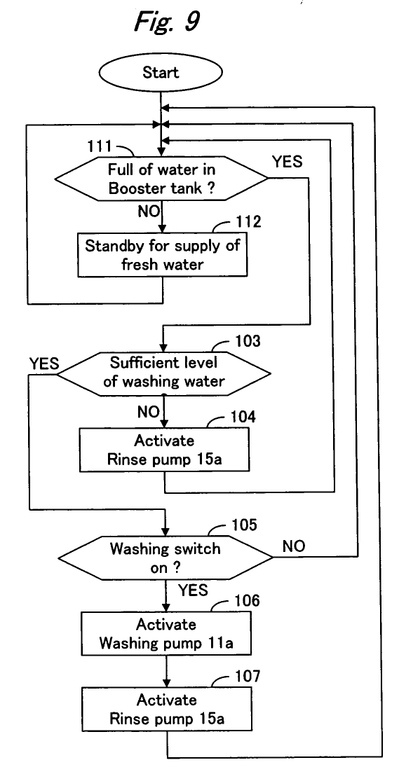

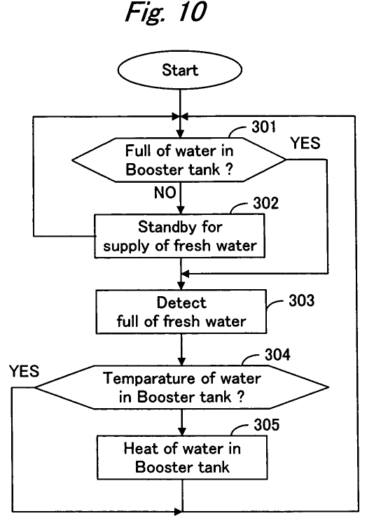

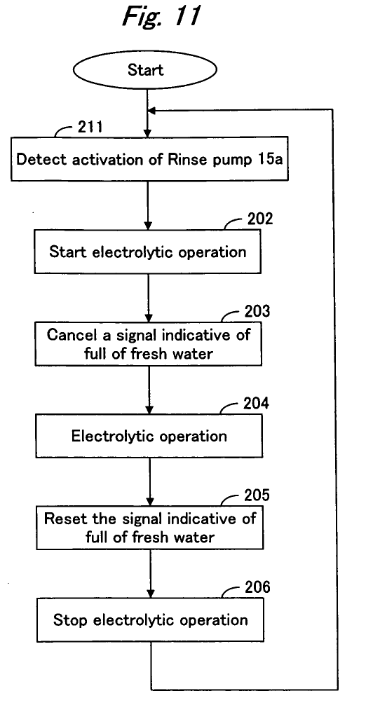

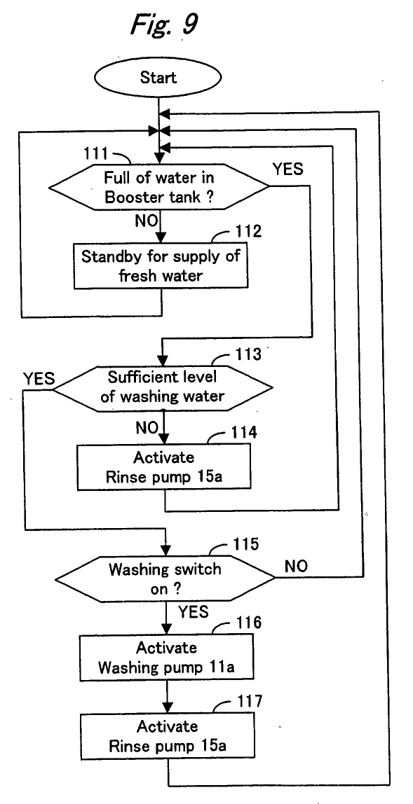

A control program for washing operation in the dishwasher A4 is shown by a flow chart in FIG. 9, and a control program for preparation of rinse water is shown by a flow chart in FIG. 10. In addition, a control program for electrolytic operation of an electrolyzed water production apparatus B4. In operation of the dishwasher A4, the controller determines at step 111 of the control program whether the level of fresh water in the booster tank 16a is the predetermined full level or not. If the answer at step 111 is “No”, the controller will stand by for supply of fresh water at step 112 for a predetermined time. When the answer at step 111 becomes “Yes”, the controller determines at step 113 whether the amount of water in the washing tank 11 is sufficient or not. If the answer at step 113 is “No”, the controller activates the rinse pump 15a to supply hot rinse water from the booster tank 16a into the rinse nozzle 13 and returns the program to step 111. When the answer at step 113 becomes “Yes”, the controller determines at step 115 whether the switch for washing operation is turned on or not. If the answer at step 115 is “No”, the controller returns the program to step 111. When the switch for washing operation is turned on, the controller activates the washing pump 11a at step 116 to start operation at a washing process. When the operation at the washing process stops after lapse of a predetermined time, the controller opens a drain valve (not shown) of the washing tank 11 to drain the used washing water. Thereafter, the controller activates the rinse pump 15a at step 117 to start operation at a rinse process and returns the program to step 111 after finish of the operation at the rinse process.

During such operation of the washing pump 11a and rinse pump 15a, the controller starts to execute the control program for preparation of rinse water shown in FIG. 10. At step 301, the controller determines whether the level of fresh water in the booster tank 16a is sufficient or not. If the answer at step 301 is “No”, the controller opens the water supply valve 24 at step 302 and is maintained on standby for supply of fresh water from the source of water into the booster tank 16a. When the booster tank 16a is fully filled with the fresh water, the controller determines a “Yes” answer at step 301 and causes the program to proceed to step 303. When received at step 303 a signal indicative of the fact that the booster tank 16a is fully filled with the fresh water, the controller determines at step 304 whether the water temperature in booster tank 16a rises up to a predetermined value or not. If the answer at step 304 is “No”, the controller causes the booster tank 16a at step 305 to heat the fresh water stored therein and returns the program to step 301. If the answer at step 304 is “Yes”, the controller returns the program to step 301.

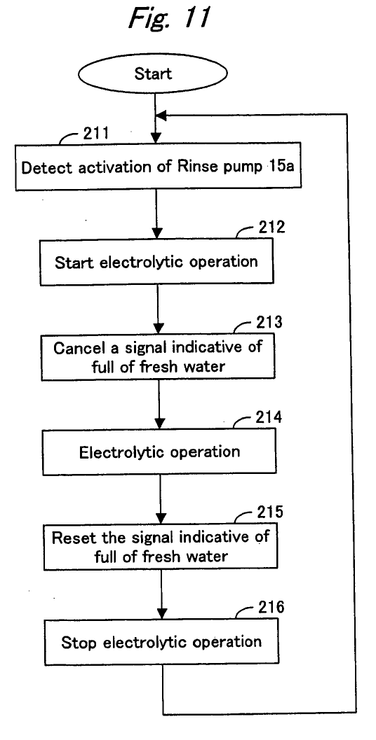

On the other hand, the controller executes the control program for electrolytic operation shown in FIG. 11. When detected the operation of rinse pump 15a at step 211, the controller activates the electrolyzed water production apparatus B4 at step 212 and cancels at step 213 the signal indicative of the fact that the booster tank 16a is fully filled with the fresh water. Subsequently, the controller maintains at step 214 the activated condition of the electrolyzed water production apparatus for a predetermined time. After lapse of the predetermined time, the controller releases the cancel of the signal from the booster tank 16a at step 215 and deactivates the electrolyzed water production apparatus.

What is claimed is:

1. A control system of a dishwasher in combination with an electrolyzed water production apparatus installed independently from the dishwasher, wherein electrolyzed alkaline water stored in a washing tank from the electrolyzed water production apparatus is used as washing water at a washing process and fresh water stored in a rinse tank from a source of water is used as rinse water at a rinse process, after the washing process; comprising the steps of
activating the dishwasher to start operation at the rinse process so that the rinse water from the rinse tank is supplied into and stored in the washing tank;
introducing the electrolyzed strong alkaline water into the washing tank in response to start of operation at the rinse process so that the alkaline water is diluted with the rinse water in the washing tank; and
stopping the introduction of the electrolyzed alkaline water into the washing tank after lapse of a predetermined time.

2. A control system of a dishwasher as claimed in claim 1, wherein the supply of fresh water into the rinse tank is stopped during introduction of the electrolyzed alkaline water into the washing tank.

3. A control system of a dishwasher as claimed in claim 2, wherein supply of the rinse water into the rinse tank is permitted during operation of the dishwasher at the washing process.

4. A control system of a dishwasher in combination with an electrolyzed water production apparatus installed independently from the dishwasher, wherein electrolyzed alkaline water stored in a washing tank from the electrolyzed water production apparatus is used as washing water at a washing process and hot water stored in a rinse tank from a booster tank is used as rinse water at a rinse process, after the washing process; comprising the steps of:
activating the dishwasher to start operation at the rinse process so that the rinse water from the rinse tank is supplied into and stored in the washing tank;
introducing the electrolyzed strong alkaline water into the washing tank in response to start of operation at the rinse process so that the alkaline water is diluted with the rinse water in the washing tank; and
stopping the introduction of the electrolyzed alkaline water into the washing tank after lapse of a predetermined time.

5. A control system of a dishwasher as claimed in claim 4, wherein fresh water supplied into the booster tank is heated in a condition where the booster tank was fully filled with the fresh water.
